(19) United States
(12) Patent Application Publication
(10) Pub. No.: US 2015/0124646 A1
(43) Pub. Date: May 7, 2015

(54) DEVICE-TO-DEVICE COMMUNICATION METHOD AND APPARATUS

(71) Applicant: ELECTRONICS AND TELECOMMUNICATIONS RESEARCH INSTITUTE, Daejeon (KR)

(72) Inventors: Mi Young YUN, Daejeon (KR); JaeSheung SHIN, Daejeon (KR); Sung-Min OH, Daejeon (KR); Changhee LEE, Seoul (KR); Ae-Soon PARK, Daejeon (KR)

(73) Assignee: ELECTRONICS AND TELECOMMUNICATIONS RESEARCH INSTITUTE, Daejeon (KR)

(21) Appl. No.: 14/527,511

(22) Filed: Oct. 29, 2014

(30) Foreign Application Priority Data
Nov. 1, 2013 (KR) 10-2013-0132543
Sep. 18, 2014 (KR) 10-2014-0124609

(51) Int. Cl. H04W 72/00; H04L 29/08; H04W 76/02; H04W 4/06; H04L 29/12

(52) U.S. Cl. CPC H04W 72/005; H04W 4/06; H04L 61/2069; H04W 76/021; H04L 67/1051
USPC 370/254; 370/312

(57) ABSTRACT

A D2D (Device-to-Device) communication method is provided which enables a first terminal of a first group to directly communicate with other terminals of the first group without relay of a base station. The first terminal receives first data from a second terminal. The first terminal determines whether the first data is destined for the first group by using a group identifier of the first data. When the first data is destined for the first group, the first terminal identifies at least one first RLC entity, among multiple RLC (Radio Link Control) entities, that corresponds to the second terminal by using the source terminal identifier of the first data.

### CROSS-REFERENCE TO RELATED APPLICATION

This application claims priority to and the benefit of Korean Patent Application No. 10-2013-0132543 and 10-2014-0124609 filed in the Korean Intellectual Property Office on Nov. 1, 2013 and Sep. 18, 2014, the entire contents of which are incorporated herein by reference.

### BACKGROUND OF THE INVENTION

(a) Field of the Invention

The present invention relates to a D2D (Device-to-Device) communication method and apparatus which enable direct communication between terminals without relay of a base station.

(b) Description of the Related Art

Standardization for D2D group communications (e.g., broadcast and multicast) is underway, which enables direct communication between terminals without relay of a base station, in an LTE (Long Term Evolution)-advanced system. In one-to-M D2D group communication which enables one terminal to directly communicate with a plurality of terminals without relay of a base station, IP (Internet Protocol) packet-based service is used, PDCP (Packet Data Convergence Protocol) allows for header-compression/decompression, RLC (Radio Link Control) UM (Unacknowledged Mode) mode is used, and HARQ (Hybrid Automatic Repeat request) feedback is not used.

Meanwhile, no discussion has yet been conducted on methods for PDCP/RLC/MAC (Medium Access Control) protocol setting for D2D group communication, message flows, and identifiers.

The above information disclosed in this Background section is only for enhancement of understanding of the background of the invention and therefore it may include information that does not form the prior art that is already known in this country to a person of ordinary skill in the art.

### SUMMARY OF THE INVENTION

The present invention has been made in an effort to provide a method and apparatus for supporting broadcast service or multicast service between terminals being in direct communication with each other in an LTE-Advanced system.

An exemplary embodiment of the present invention provides a D2D (Device-to-Device) communication method which enables a first terminal of a first group to directly communicate with other terminals of the first group without relay of a base station. The D2D communication method includes: receiving first data from a second terminal; determining whether the first data is destined for the first group by using a group identifier of the first data; and when the first data is destined for the first group, identifying at least one first RLC entity, among multiple RLC (Radio Link Control) entities, that corresponds to the second terminal by using a source terminal identifier of the first data.

The source terminal identifier and the group identifier may be included in a MAC (Medium Access Control) header of the first data.

The D2D communication method may further include, prior to receiving the first data, pre-configuring RRC (Radio Resource Control) information for the first terminal without RRC signaling.

The D2D communication method may further include processing the first data through a second RLC entity.

The identifying of the first RLC entity may include: identifying the at least one first RLC entity among the multiple RLC entities by using the source terminal identifier of the first data; and identifying the second RLC entity, among the at least one first RLC entity, that corresponds to an LCID (Logical Channel Identifier) of the first data.

The D2D communication method may further include, if the multiple RLC entities do not include the first RLC entity, creating the first RLC entity.

The second terminal may include one RLC entity for D2D group communication.

The first data may be broadcast or multicast through the RLC entity of the second terminal.

The determining of whether the first data is destined for the first group may include determining whether the first data is destined for the first group by using an LCID of the first data as the group identifier of the first data.

The D2D communication method may further include identifying at least one first PDCP entity, among multiple PDCP (Packet Data Convergence Protocol) entities, that corresponds to the second terminal by using the source terminal identifier of the first data.

The D2D communication method may further include, when the multiple PDCP entities do not include the first PDCP entity, creating the first PDCP entity.

The D2D communication method may further include, prior to receiving the first data, receiving an RRC message including RRC information for configuration from the second terminal.

The D2D communication method may further include, prior to receiving the first data, receiving the source terminal identifier of the first data from the second terminal.

The D2D communication method may further include receiving notification from the second terminal that data transmission is completed.

Another exemplary embodiment of the present invention provides a D2D (Device-to-Device) communication method which enables a first terminal of a first group to directly communicate with other terminals of the first group without relay of a base station. The D2D communication method includes: receiving first data from a second terminal; creating one RLC entity for D2D group communication; determining whether the first data is destined for the first group by using a group identifier of the first data; when the first data is destined for the first group, finding out an RLC SN (Sequence Number) of the first data through the RLC entity of the first terminal; and when the RLC SN of the first data has a specific value, resetting a receive buffer.

When the first data is new data or data that is re-transmitted after completion of continuous data transmission, the RLC SN of the first data may be set to the specific value through the RLC entity of the second terminal.

The determining of whether the first data is destined for the first group may include determining whether the first data is destined for the first group by using an LCID of the first data as the group identifier of the first data.

The D2D communication method may further include, prior to receiving the first data, receiving a source terminal identifier of the first data from the second terminal.

The D2D communication method may further include receiving notification from the second terminal that data transmission is completed.

The D2D communication method may further include, after receiving the first data, creating one PDCP entity corresponding to the RLC entity.

Yet another exemplary embodiment of the present invention provides a D2D (Device-to-Device) communication method which enables a first terminal of a first group to directly communicate with other terminals of the first group without relay of a base station. The D2D communication method includes: being selected as a group owner of the first group; receiving first data from a second terminal of the first group; setting a destination of the first data as the first group; and transmitting the first data.

### BRIEF DESCRIPTION OF THE DRAWINGS

FIG. 1 is a view showing a D2D group communication method using a group owner according to an exemplary embodiment of the present invention.

FIG. 2 is a view showing a D2D group communication method using no group owner according to an exemplary embodiment of the present invention.

FIG. 3 is a view showing an entity structure of Layer 2 for a sending terminal according to an exemplary embodiment of the present invention.

FIG. 4 is a view showing an entity structure of Layer 2 for a receiving terminal according to an exemplary embodiment of the present invention.

FIG. 5 is a flowchart showing a process for a terminal to perform D2D group communication according to an exemplary embodiment of the present invention.

FIG. 6 is a view showing an entity structure of Layer 2 for a sending terminal according to another exemplary embodiment of the present invention.

FIG. 7 is a view showing an entity structure of Layer 2 for a receiving terminal according to another exemplary embodiment of the present invention.

FIG. 8 is a view showing the configuration of a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a terminal may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), a node, etc., or may include all or part of the MT, the MS, the AMS, the HR-MS, the SS, the PSS, the AT, the UE, the node, etc.

A base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay (MMR-BS), a relay station (RS) serving as a base station, a high reliability relay station (HR-RS) serving as a base station, a small base station, etc., and may include all of part of the functions of the ABS, the nodeB, the eNodeB, the AP, the RAS, the BTS, the MMR-BS, the RS, the HR-RS, the small base station, etc.

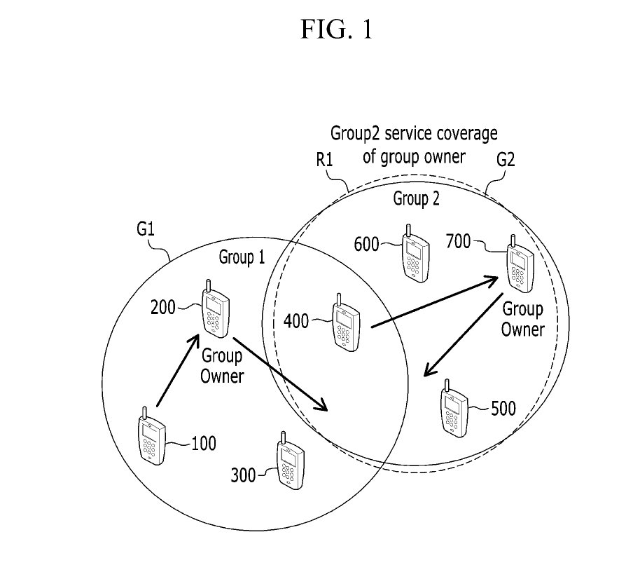

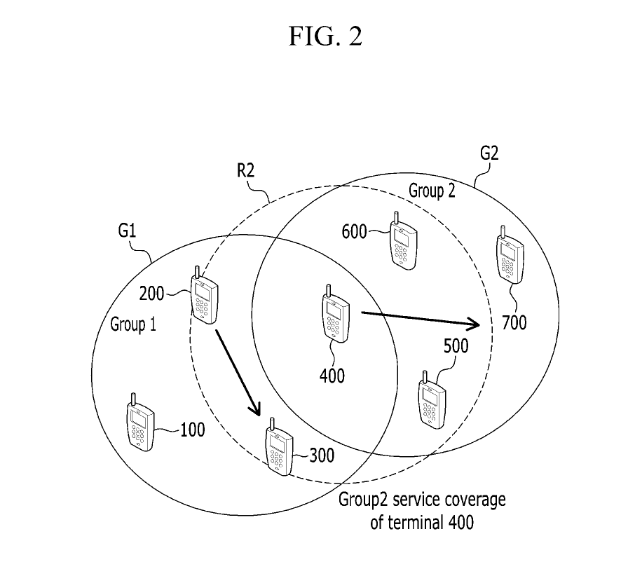

In broadcast or multicast communication between terminals directly communicating with each other, as defined in the standards, a terminal belonging to a group cannot find out whether or not the other terminal has received data it has sent. Accordingly, a D2D group communication method using a group owner and a D2D group communication method using no group owner can be taken into consideration. The D2D group communication method using a group owner will be explained with reference to FIG. 1, and the D2D group communication method using no group owner will be explained with reference to FIG. 2.

FIG. 1 is a view showing a D2D group communication method (hereinafter, ‘first D2D group communication method’) using a group owner according to an exemplary embodiment of the present invention. For ease of explanation, FIG. 1 illustrates that a first group G1 includes terminals 100, 200, 300, and 400 and a second group G2 includes terminals 400, 500, 600, and 700. The terminal 400 belongs to both the first group G1 and the second group G2.

A group owner is defined for each of the groups G1 and G2, which manages communication within each group. For example, the terminal 200 may be set as the group owner for the first group G1, and the terminal 700 may be set as the group owner for the second group G2.

The terminals 100 to 700 within the groups G1 and G2 send traffic for multicast or broadcast transmission to the group owner terminals 200 and 700. For example, the terminal 100 of the first group G1 may send desired data to the group owner terminal 200. For another example, the terminal 400 may send desired data (e.g., data for the second group G2) to the group owner terminal 700.

Upon receiving traffic, the group owner terminals 200 and 700 perform multicast or broadcast transmission in place of the terminal that has sent the traffic. For example, having received data from the terminal 100, the group owner terminal 200, in place of the terminal 100, may broadcast or multicast the received data to the first group G1 as a destination. For another example, having received data from the terminal 400, the group owner terminal 700, in place of the terminal 400, may broadcast or multicast the received data to the first group G2 as a destination.

The data reception range of the terminals 100 to 700 of the groups G1 and G2 is consistent with the radius of communication of the group owner terminals 200 and 700. Accordingly, the first D2D group communication method is advantageous in that service coverage remains fixed even if a terminal that intends to transmit data is changed. For example, even when the terminal 500 of the second group G2 sends data to the group owner terminal 700 after the terminal 400 of the second group G2 has sent data to the group owner terminal 700, the service coverage R1 for the second group G2 of the group owner terminal 700 remains fixed.

However, the first D2D group communication method has the drawback that it needs a mechanism for the terminals 100 to 700 to select a group owner within the radius of communication. Another drawback of the first D2D group communication method is that radio resources are wasted and latency increases because a sending terminal within each group G1 or G2 sends data to the group owner terminal and the group owner terminal 200 or 700 transmits the received data.

FIG. 2 is a view showing a D2D group communication method (hereinafter, ‘second D2D group communication method’) using no group owner according to an exemplary embodiment of the present invention. For ease of explanation, FIG. 2 illustrates that a first group G1 includes terminals 100 to 400 and a second group G2 includes terminals 400 to 700. The terminal 400 belongs to both the first group G1 and the second group G2.

When the terminals 100 to 700 within the groups G1 and G2 want to send data, they may transmit data themselves. For example, the terminal 200 of the first group G1 may broadcast or multicast data to the first group G1 as a destination. For another example, the terminal 400 may broadcast or multicast data to the second group G2 as a destination. Specifically, when the terminal 200 or the terminal 400 wants to broadcast data, the terminal 200 or the terminals 400 configures a destination, not as a group address (e.g., G1, G2), but as a specific address, in order to transmit data to all adjacent terminals. Hereinafter, the broadcasting of data by a terminal means that a terminal transmits data to all adjacent terminals by configuring a destination as a specific address corresponding to a broadcast.

As compared to the first D2D group communication method, the second D2D group communication method has the drawback that the service coverage of group communication changes with the location of a sending terminal. For example, when the terminal 400 wants to send data for the second group G2, the service coverage R2 for the second group G2 of the terminal 400 may be changed depending on the location of the terminal 400. The receipt or failure of receipt of data cannot be checked in D2D group communication, and if the service coverage of group communication frequency changes with the location of a terminal, this makes it even more difficult to confirm whether service is received or not.

The second D2D group communication method, however, has the merit of wasting less radio resources compared to the first D2D group communication method. Hereinafter, transmission/reception techniques based on the second D2D group communication method will be described.

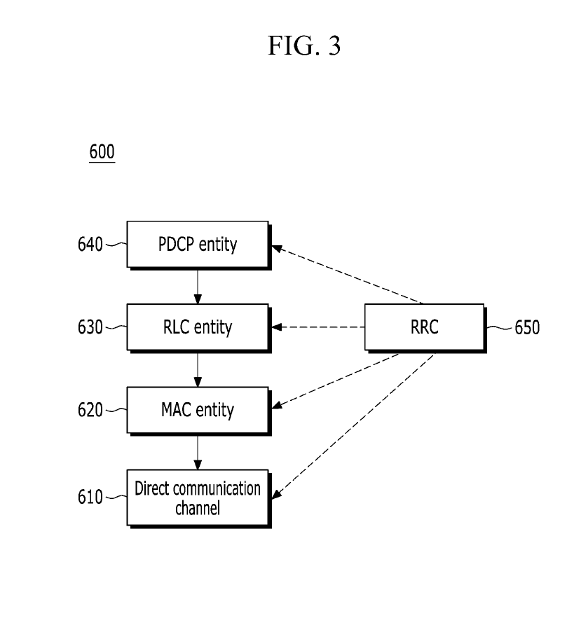

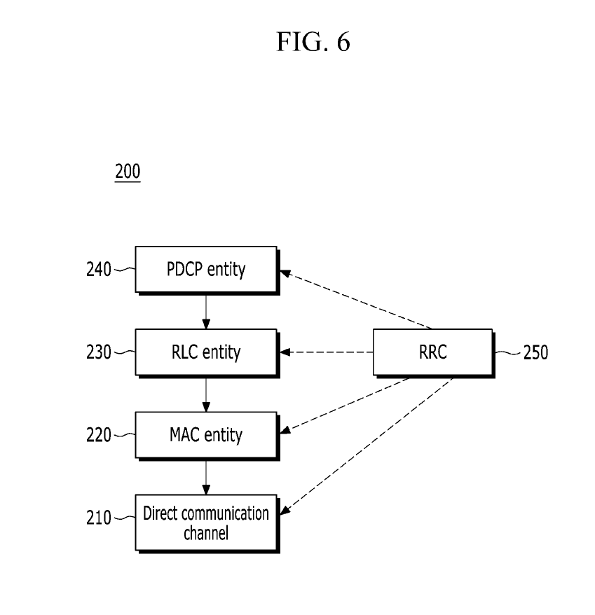

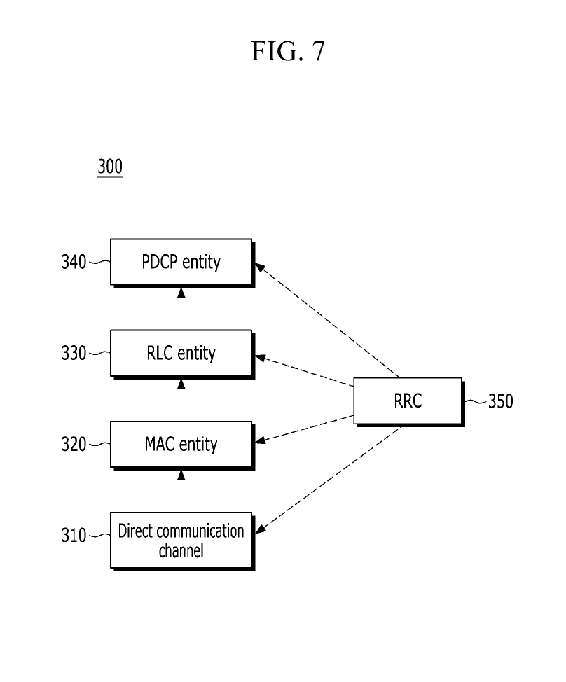

In the existing data services, a terminal receives data transmitted by one node (i.e., a base station). On the other hand, in broadcast or multicast services between terminals being in direct communication with each other, one terminal has to receive traffic sent by multiple terminals. To this end, changes need to be made to the transmission/reception protocols. Particularly, one terminal can perform one-to-one communication with multiple terminals through the introduction of a data receiving module into a base station. However, in order for one terminal to receive one service sent by multiple terminals (i.e., in order for one terminal to receive broadcast or multicast data transmitted by multiple groups within the same group), an entity structure of Layer 2 needs to be considered. A first entity structure will be described in detail with reference to FIGS. 3 to 5, and a second entity structure will be described with reference to FIGS. 6 and 7.

FIG. 3 is a view showing an entity structure of Layer 2 for a sending terminal according to an exemplary embodiment of the present invention. For ease of explanation, FIG. 3 illustrates that the terminal 600 transmits data for the second group G2.

When the terminal 600 wants to transmit data, it creates one PDCP entity 640, one RLC entity 630, and one MAC entity 620 per D2D group communication. The PDCP entity 640 performs the function of a PDCP protocol, the RLC entity 630 performs the function of an RLC protocol, and the MAC entity 620 performs the function of a MAC protocol.

An RRC 650 of the terminal 600 configures the PDCP entity 640, the RLC entity 630, the MAC entity 620, and a direct communication channel 610, respectively, and manages the PDCP entity 640, the RLC entity 630, the MAC entity 620, and the direct communication channel 610. The direct communication channel 610 is a physical channel of a PHY (Physical) layer for D2D communication.

The terminal 600 configures (or maps) a group identifier to data it wants to transmit. Assignment of the group identifier may be pre-configured or the terminal 600 may receive the group identifier over a network. For example, the terminal 600 may use an LCID (Logical Channel Identifier) as a group identifier. Also, the terminal 600 may additionally assign an RBID (Radio Bearer Identifier) and a source node identifier for data it wants to transmit. The source node identifier represents a data transmitting terminal.

The terminal 600 broadcasts or multicasts data through the PDCP entity 640, the RLC entity 630, the MAC entity 620, and the direct communication channel 610. The data transmitted by the terminal 600 includes a group identifier representing the second group G2 and a source node identifier of the terminal 600.

FIG. 3 illustrates an entity structure of the terminal 600 joining one group G2. If the terminal 600 is joining two or more groups, it may create multiple RLC entities and multiple PDCP entities depending on the number of groups it is joining. Alternatively, the terminal 600 may create an RLC entity and a PDCP entity, for the LCID of each group it is joining.

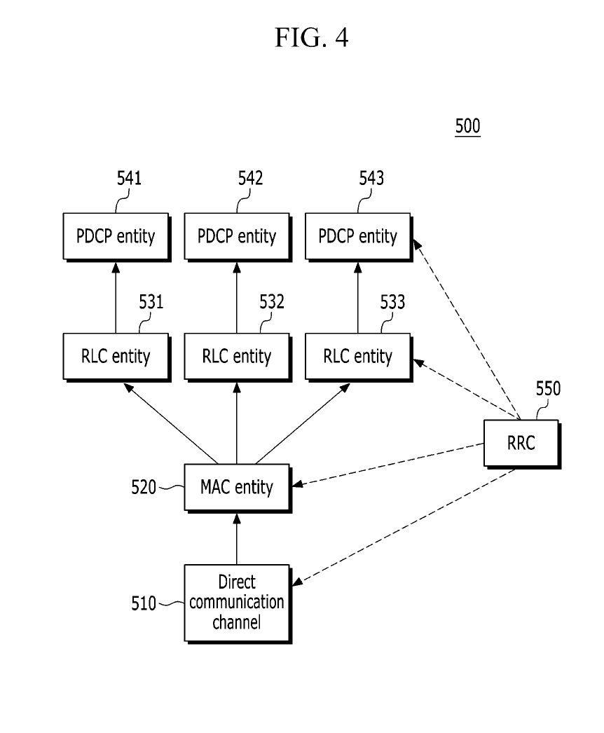

FIG. 4 is a view showing an entity structure of Layer 2 for a receiving terminal according to an exemplary embodiment of the present invention. For ease of explanation, FIG. 4 illustrates that the terminal 500 receives data transmitted by the terminals 400, 600, and 700 of the second group G2.

A direct communication channel 510 of the terminal 500 receives data according to a schedule defined in a standard specification. The direct communication channel 510 is a physical channel of the PHY layer for D2D communication.

The terminal 500 creates one MAC entity 520 for D2D group communication. The MAC entity 520 determines whether the group identifier of received data represents the group (e.g., G2) to which the terminal 500 belongs. Specifically, the MAC entity 520 may determine whether received data is destined for the second group G2 that the terminal 500 is joining, through the LCID (consisting of 5 bits) of the received data. A base station may have one MAC entity.

The terminal 500 creates RLC entities 531 to 533 and PDCP entities 541 to 543 for D2D group communication. Specifically, if the group identifier of receive data represents the group G2 that the terminal 500 is joining, the terminal 500 may create at least one RLC entity for each sending terminal and at least one PDCP entity for each sending terminal. For example, when initially receiving data from the terminal 600 of the second group G2 (when the RLC entity and PDCP entity for the terminal 600 of the second group G2 have not been created), the terminal 500 may create the RLC entity 531 and PDCP entity 541 for the terminal 600 of the second group G2. For another example, when initially receiving data from the terminal 700 of the second group G2, the terminal 500 may create an RLC entity 532 and PDCP entity 542 for the terminal 700 of the second group G2. For yet another example, when initially receiving data from the terminal 400 of the second group G2, the terminal 500 may create an RLC entity 533 and PDCP entity 543 for the terminal 400 of the second group G2. Also, the terminal 500 may create an RLC entity and PDCP entity for each link of a sending terminal. For example, there are three links (of different QoS (Quality of Service) levels) between the terminal 500 and the terminal 600, and the terminal 500 may create three RLC entities and three PDCP entities, corresponding to the three links. Also, the terminal 500 may create an RLC entity and PDCP entity for each bearer. Further, the terminal 500 may create an RLC entity and PDCP entity for each sending terminal of each of the groups it is joining.

An RRC 550 manages the direct communication channel 510, the MAC entity 520, the RLC entities 531 to 533, and the PDCP entities 541 to 543.

For ease of explanation, a receiving operation of the terminal 500 will be described with an example where the RLC entities 531 and 532 and PDCP entities 541 and 542 for the terminals 600 and 700 of the second group G2 are created and the terminal 500 receives data broadcast and multicast by the terminals 600 and 700 of the second group G2. First, when the terminal 500 receives data transmitted by the terminal 600 over the direct communication channel 510, the MAC entity 520 determines whether the group identifier (e.g., LCID) of the received data represents the second group G2 that the terminal 500 is joining. If the group identifier of the received data represents the second group G2, the MAC entity 520 identifies a mapped RBID using the source node identifier (representing the terminal 600) of the received data.

The RBID may be a unit for identifying a link defined by a source node identifier and a group identifier.

Specifically, the MAC entity 520 may identify an RBID mapped to the source node identifier and group identifier (e.g., LCID) of the received data, and send a MAC SDU to the RLC entity 531 corresponding to the source node identifier, group identifier, and RBID. The RLC entity 531 processes the MAC SDU, and sends an RLC SDU extracted from the MAC SDU to the PDCP entity 541. The PDCP entity 541 processes the RLC SDU. Afterwards, when the terminal 500 receives data transmitted by the terminal 700, the same operation as above is performed. Specifically, the MAC entity 520 determines whether the group identifier of the received data represents the second group G2 that the terminal 500 is joining. If the group identifier of the received data represents the second group G2, the MAC entity 520 sends a MAC SDU to the RLC entity 532 corresponding to the source node identifier (representing the terminal 700) and LCID of the received data. Then, the RLC entity 532 sends an RLC SDU extracted from the MAC SDU to the PDCP entity 542.

RRC information used for configuration may be pre-configured for the terminal 500 without RRC signaling, before the terminal 500 receives data. The RRC signaling refers to signaling between terminals participating in D2D communication. Alternatively, the RRC information used for configuration may be pre-configured over a network before the terminal 500 receives data. Alternatively, configuration-related information (e.g., information related to the type of file download) may be pre-configured within the terminal 500. Alternatively, the RRC information used for configuration may be sent and received through an RRC message before the terminal 500 receives data. For example, the terminal 500 may receive configuration information from the opposing terminal of D2D communication through an RRC message before receiving data. The terminal 500 may receive data after receiving an RRC message.

The RLC entities 531 to 533 use RLC SN (Sequence Number) in UM mode for the purpose of duplication, reordering, or loss detection of received RLC SDU (Service Date Unit). The RLC entities 531 to 533 receive RLC SN which increases by 1 on each reception. When multiple terminals 400, 600, and 700 within the second group G2 send data, the RLC SN or PDCP SN generated by each terminal 400, 600, and 700 may have a different value for each terminal. Despite all of that, the terminal 500 is able to receive data properly since the sending terminals include the RLC entities 531 to 533 and PDCP entities 541 to 543, respectively.

The number of sending terminals within each group G1 or G2 may be limited to the number of RBIDs. Particularly, if a terminal (e.g., 400) has subscribed to a number of services, a number of RLC entities and PDCP entities may be created. However, even if the terminal 400 has subscribed to a number of services, the terminal 400 automatically creates an RLC entity and a PDCP entity based on information (e.g., group identifier and source identifier) about a data transmitting terminal after receiving data. In conclusion, the first entity structure has the advantage of minimizing changes to the existing standards.

In the first entity structure, if the MAC entity 520 uses an LCID to identify a group, the LCID may be defined as in the following Table 1. A group identifier (e.g., LCID) may be included in a MAC subheader.

TABLE 1

| index | LCID values |
|---|---|
| 00000-11101 | group identifier |
| 11110 | Reserved |
| 111111 | Padding |

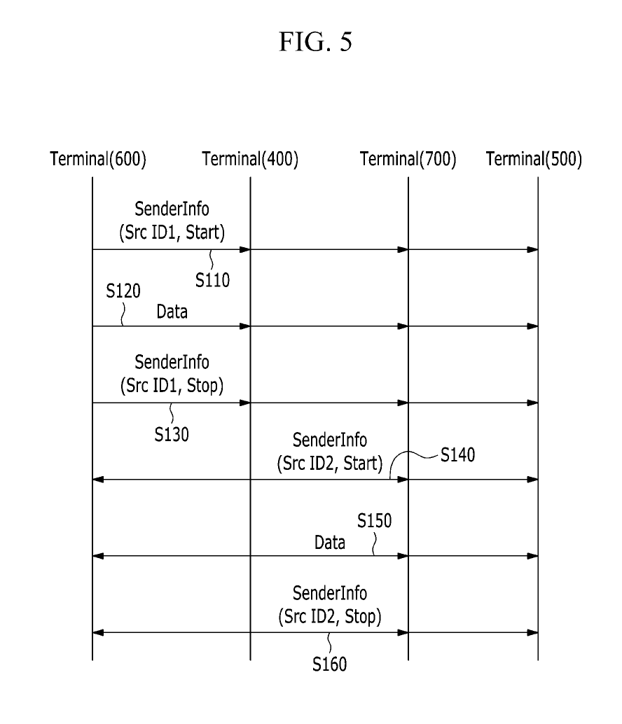

In the first entity structure, the MAC entity 520 requires identifier information (source node identifier) of a terminal that has sent traffic, as well as the group identifier. The source node identifier may be sent through the MAC subheader, but this may increase the overhead at the MAC transport layer. Accordingly, there is a need for a method of transmitting a source node identifier while minimizing overhead. The method of transmitting a source node identifier will be described in detail with reference to FIG. 5.

FIG. 5 is a flowchart showing a process for a terminal to perform D2D group communication according to an exemplary embodiment of the present invention. For ease of explanation, FIG. 5 illustrates D2D group communication between the terminals 400 to 700 of the second group G2.

The terminal 600 transmitting broadcast traffic or multicast traffic transmits (broadcasts or multicasts) its information Senderinfo in advance before transmitting traffic (S110). The transmitted information Senderinfo includes a source node identifier SrcID1 representing the terminal 600 and traffic transfer startup information Start. This information lets the other terminals 400, 500, and 700 know in advance about the terminal 600 that generates traffic they will receive later on.

The terminal 600 broadcasts or multicasts data after transmitting its information Senderinfo (S120).

Also, upon completion of data transmission, the terminal 600 may transmit (broadcast or multicast) the information Senderinfo to notify the members 400, 500, and 700 of the second group G2 of the completion of data transmission (S130). The information Senderinfo transmitted in the step S130 includes the source node identifier SrcID1 representing the terminal 600 and traffic transfer stop information Stop. This information lets the other terminals 400, 500, and 700 of the second group G2 explicitly know that the terminal 600 has completed data transmission. Having sent the information Senderinfo in the step S130, the terminal 600 may delete the RLC entity and PDCP entity associated with the second group G2. Having received the information Senderinfo in the step S130, the terminals 400, 500, and 700 may delete the RLC entity and PDCP entity associated with the terminal 600 of the second group G2. According to the D2D group communication method explained with reference to FIG. 5, power can be saved under an environment where distributed scheduling is used.

The terminal 400 wanting to transmit data, once informed that the terminal 600 has completed data transmission, may become a new sender and start data transmission through the same steps as S110 to S130 (S140 to S160). Specifically, the terminal 400 broadcasts or multicasts its information Senderinfo in order to notify the other terminals 500 to 700 of the second group G2 of the start of data transmission (S140). The information Senderinfo transmitted in the step S140 includes a source node identifier SrcID2 representing the terminal 400 and traffic transfer start information Start. The terminal 400 broadcasts or multicasts data after transmitting its information Senderinfo (S150). The terminal 400 broadcasts or multicasts the information Senderinfo in order to notify the members 500 to 700 of the second group G2 of completion of data transmission (S160). The information Senderinfo transmitted in the step S160 includes the source node identifier SrcID2 representing the terminal 400 and traffic transfer stop information Stop.

In the second entity structure, unlike the first entity structure, sending and receiving terminals of D2D group communication create one entity for each protocol (e.g., one MAC entity, one RLC entity, and one PDCP entity), as is the case with the existing services. Accordingly, additional functions should be defined for the existing standards of the second entity structure. The second entity structure will be described in detail with reference to FIGS. 6 and 7.

FIG. 6 is a view showing an entity structure of Layer 2 for a sending terminal according to another exemplary embodiment of the present invention. For ease of explanation, FIG. 6 illustrates that the terminal 200 broadcasts or multicasts data for the first group G1.

When the terminal 200 wants to transmit data, it creates one MAC entity 220, one RLC entity 230, and one PDCP entity 240, for D2D group communication.

An RRC 250 of the terminal 200 manages the PDCP entity 240, the RLC entity 230, the MAC entity 220, and a direct communication channel 210, respectively. The direct communication channel 210 is a physical channel of the PHY layer for D2D communication.

The terminal 200 assigns a group identifier representing the first group G1 to data it wants to transmit. For example, the terminal 200 may use an LCID as a group identifier. Also, the terminal 200 may additionally assign an RBID (Radio Bearer Identifier) and a source node identifier representing the terminal 200 to data it wants to transmit.

The terminal 200 broadcasts or multicasts data through the PDCP entity 240, the RLC entity 230, the MAC entity 220, and the direct communication channel 210.

If the terminal 200 wants to transmit new data or wants to re-transmit data after completion of continuous data transmission (after a certain period of time after the completion of continuous data transmission), it may always set RLC SN or PDCP SN to a first specific value (e.g., 0) so that data can be transmitted.

FIG. 7 is a view showing an entity structure of Layer 2 for a receiving terminal according to another exemplary embodiment of the present invention. For ease of explanation, FIG. 7 illustrates that the terminal 300 of the first group G1 receives data transmitted by the terminals 100, 200, and 400 of the first group.

A direct communication channel 310 of the terminal 300 receives data according to a schedule defined in a standard specification. The direct communication channel 310 is a physical channel of the PHY layer for D2D communication.

Upon receiving data through the direct communication channel 310, the terminal 300 creates one MAC entity 320, one RLC entity 330, and one PDCP entity 340, for D2D group communication. The MAC entity 320 determines whether the group identifier of received data represents the group (e.g., G1) to which the terminal 300 belongs. For example, the MAC entity 320 may use the LCID of received data as a group identifier. If the received data is destined for the first group G1 to which the terminal 300 belongs, the MAC entity 320 sends a MAC SDU to the RLC entity 330.

The RLC entity 330 extracts an RLC SDU from the MAC SDU and sends it to the PDCP entity 340.

The PDCP entity 340 processes the RLC SDU.

An RRC 350 of the terminal 300 manages the direct communication channel 310, the MAC entity 320, the RLC entity 330, and the PDCP entity 340.

When a sending terminal (e.g., 200) creates a new RLC entity 230 and a new PDCP entity 240, it may set RLC SN and PDCP SN by a first SN setting method or a second SN setting method. In the first SN setting method, for example, when the sending terminal 200 creates a new RLC entity 230 and a new PDCP entity 240, it may set the RLC SN and PDCP SN to a first specific value (e.g., 0) so that data can be transmitted. Upon receiving data with the RLC SN and PDCP SN of the first specific value, rather than an expected value, the receiving terminal (e.g., 300) having the existing RLC entity 330 and the existing PDCP entity 340 may implicitly recognize the re-creation of the RLC entity 230 and the PDCP entity 240. In this case, even if the RLC SN and PDCP SN of the received data do not match an expected value, the receiving terminal 300 does not run a reordering timer (i.e., without waiting for the data with the RLC SN and PDCP SN of the expected value), but instead receives the RLC SDU/PDCP SDU and transmits them to an upper layer. Specifically, if the received data is destined for the first group G1 to which the terminal 300 belongs, the RLC entity 330 checks the RLC SN of the received data. If the RLC SN of the received data has a first specific value (e.g., 0), rather than an expected value, the terminal 300 resets all receive buffers and receive a new RLC SDU. For example, if the terminal 300 receives data broadcast or multicast by the terminal 200, the group identifier of the received data represents the first group G1, and the RLC SN of the received data has a first specific value (e.g., 0), the terminal 300 resets all receive buffers since the received data is new data or data that is re-transmitted after completion of continuous data transmission. Likewise, if the PDCP SN of the received data has a first specific value (e.g., 0) rather than a value expected by the PDCP entity 340, the terminal 300 resets all receive buffers and receives a new RLC SDU. Hereupon, any fragmented RLC PDU (Protocol Data Unit) sent by the previous node may be left in the receive buffers, however, the receipt or failure of receipt of data cannot be checked in broadcast or multicast transmission for D2D group communication and data may be lost during broadcast or multicast transmission. Due to this reason, data in the receive buffers is discarded by resetting the receive buffers, and this does not lead to service degradation.

Specifically, while the receiving terminal (e.g., 300) is waiting for the next data because there is fragmented data left in the receive buffers, if the RLC SN and PDCP SN of data received by the receiving terminal 300 have a first specific value (e.g., 0) rather than an expected value, the receiving terminal 300 may reset the receive buffers. Alternatively, while the reordering timer is running by the receiving terminal 300 and the receiving terminal 300 is waiting for any data lost during transmission, if the RLC SN and PDCP SN of data received by the receiving terminal 300 has a first specific value (e.g., 0) rather than an expected value, the receiving terminal 300 may stop the reordering timer and forward any non-fragmented data left in the receive buffers or discard all the data left in the receive buffers.

On the other hand, in the second SN setting method, if the sending terminal (e.g., 200) creates a new RLC entity 230 and a new PDCP entity 240, it can maintain the RLC SN and PDCP SN used in the previous RLC and PDCP entities. Specifically, even if the sending terminal 200 creates a new RLC entity 230 and a new PDCP entity 240, it can transmit data by increasing the previous RLC SN and PDCP SN, as is conventionally done. The receiving terminal (e.g., 300) receives an RLC SDU and a PDCP SDU when creating a new RLC entity 330 and a PDCP entity 340 or initially receiving data. The RLC entity 330 uses RLC SN in UM mode for the purpose of duplication, reordering, or loss detection of received RLC SDU (Service Date Unit). The RLC entity 330 receives RLC SN which increases by 1 on each reception. On the other hand, when multiple terminals 100, 200, and 400 within the first group G1 send data, the RLC SN or PDCP SN generated by each terminal 100, 200, and 400 may have a different value for each terminal. To overcome this problem, in the first entity structure, the receiving terminal has to create multiple RLC entities and PDCP entities (e.g., as many RLC entities and PDCP entities as sending terminals of each group to which the receiving terminal belongs) and get information (e.g., a source node identifier) about a traffic sending node. On the other hand, in the second entity structure, this problem can be overcome through a defined internal procedure (e.g., resetting the receive buffers according to RLC SN or PDCP SN) even if the receiving terminal 300 creates one RLC entity 330 and one PDCP entity 340. A receive buffer reset operation for the above-described first SN setting method applies to the first entity structure as well as to the second entity structure.

However, although the second entity structure requires no source node identifier for identifying a traffic sending terminal, if a new node transmits data before the previous node completes data transmission, the data generated by the previous node may be lost. To solve this problem, the above-described procedure of FIG. 5 may apply to the second entity structure. Specifically, in the second entity structure, a terminal wanting to transmit data may notify the members of the group to which it belongs of the start of data transmission, and upon completion of data transmission, may notify the members of the group of the completion of data transmission. By doing so, the token for data transmission can be managed efficiently.

On the other hand, in the first entity structure, a terminal may create multiple RLC entities and PDCP entities, and if there is no particular message, the receiving terminal and the sending terminal may delete their entities and create new entities depending on the method of implementation. Accordingly, a terminal, when transmitting data, may explicitly notify of the creation and deletion of transmission entities by using a MAC CE (Control Element) or an additional MAC header. That is, a terminal may transmit information about the creation and deletion of transmission entities, along with data, without using an RRC message or the like. By doing so, the SNs of RLC entities and PDCP entities can be managed efficiently.

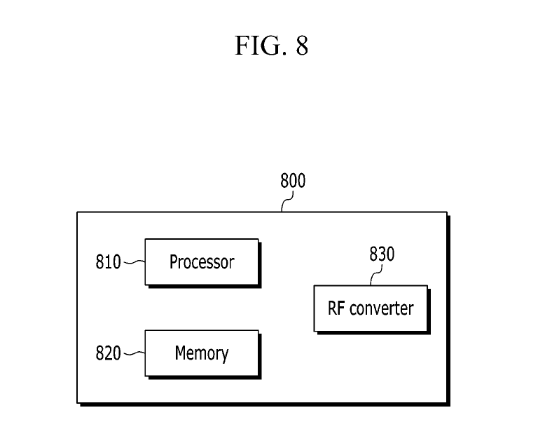

FIG. 8 is a view showing the configuration of a terminal 800 according to an exemplary embodiment of the present invention. The terminals 100 to 700 may be configured in the same or similar manner to the terminal 800.

The terminal 800 includes a processor 810, a memory 820, and an RF (Radio Frequency, wireless frequency) converter 830.

The processor 810 may be configured to implement the procedures, functions, and methods explained in FIG. 1. Alternatively, the processor 810 may be configured to implement the procedures, functions, and methods explained in FIG. 2. Alternatively, the processor 810 may be configured to implement the procedures, functions, and methods explained in FIGS. 3 to 5. Alternatively, the processor 810 may be configured to implement the procedures, functions, and methods explained in FIGS. 6 and 7.

The memory 820 is connected to the processor 810, and stores various information related to the operation of the processor 810.

The RF converter 830 is connected to the processor 810, and sends or receives a radio signal. The terminal 800 may have a single antenna or multiple antennas.

According to an embodiment of the present invention, terminals participating in D2D communication based on an LTE-Advanced system can send and transmit broadcast service or multicast service by using the above-described protocol settings, message flows, and identifiers (e.g., a group identifier and a source node identifier).

According to an embodiment of the present invention, the same principle may apply to unicast service as well as broadcast service and multicast service.

In an embodiment of the present invention, terminals participating in D2D communication in an LTE-Advanced system can send and receive multicast service or broadcast service.

While an exemplary embodiment of the present invention has been described in detail, the protection scope of the present invention is not limited to the foregoing embodiment, and it will be appreciated by those skilled in the art that various modifications and improvements using the basic concept of the present invention defined in the appended claims are also included in the protection scope of the present invention.

What is claimed is:

1. A D2D (Device-to-Device) communication method which enables a first terminal of a first group to directly communicate with other terminals of the first group without relay of a base station, the method comprising:
receiving first data from a second terminal;
determining whether the first data is destined for the first group by using a group identifier of the first data; and
when the first data is destined for the first group, identifying at least one first RLC entity, among multiple RLC (Radio Link Control) entities, that corresponds to the second terminal by using a source terminal identifier of the first data.

2. The method of claim 1, wherein the source terminal identifier and the group identifier are included in a MAC (Medium Access Control) header of the first data.

3. The method of claim 1, further comprising, prior to receiving the first data, pre-configuring RRC (Radio Resource Control) information for the first terminal without RRC signaling.

4. The method of claim 1, further comprising processing the first data through a second RLC entity,
the identifying of the first RLC entity comprising:
identifying the at least one first RLC entity among the multiple RLC entities by using the source terminal identifier of the first data; and
identifying the second RLC entity, among the at least one first RLC entity, that corresponds to an LCID (Logical Channel Identifier) of the first data.

5. The method of claim 1, further comprising, when the multiple RLC entities do not include the first RLC entity, creating the first RLC entity.

6. The method of claim 1, wherein the second terminal comprises one RLC entity for D2D group communication, and the first data is broadcast or multicast through the RLC entity of the second terminal.

7. The method of claim 1, wherein the determining of whether the first data is destined for the first group comprises determining whether the first data is destined for the first group by using an LCID of the first data as the group identifier of the first data.

8. The method of claim 1, further comprising identifying at least one first PDCP entity, among multiple PDCP (Packet Data Convergence Protocol) entities, that corresponds to the second terminal by using the source terminal identifier of the first data.

9. The method of claim 8, further comprising, when the multiple PDCP entities do not include the first PDCP entity, creating the first PDCP entity.

10. The method of claim 1, further comprising, prior to receiving the first data, receiving an RRC message including RRC information for configuration from the second terminal.

11. The method of claim 1, further comprising, prior to receiving the first data, receiving the source terminal identifier of the first data from the second terminal.

12. The method of claim 11, further comprising receiving notification from the second terminal that data transmission is completed.

13. A D2D (Device-to-Device) communication method which enables a first terminal of a first group to directly communicate with other terminals of the first group without relay of a base station, the method comprising:
receiving first data from a second terminal;
creating one RLC entity for D2D group communication;
determining whether the first data is destined for the first group by using a group identifier of the first data;
when the first data is destined for the first group, finding out an RLC SN (Sequence Number) of the first data through the RLC entity of the first terminal; and
when the RLC SN of the first data has a specific value, resetting a receive buffer.

14. The method of claim 13, wherein the second terminal comprises one RLC entity for D2D group communication, and the first data is broadcast or multicast through the RLC entity of the second terminal.

15. The method of claim 14, wherein, when the first data is new data or data that is re-transmitted after completion of continuous data transmission, the RLC SN of the first data is set to the specific value through the RLC entity of the second terminal.

16. The method of claim 15, wherein the determining of whether the first data is destined for the first group comprises determining whether the first data is destined for the first group by using an LCID of the first data as the group identifier of the first data.

17. The method of claim 15, further comprising, prior to receiving the first data, receiving a source terminal identifier of the first data from the second terminal.

18. The method of claim 17, further comprising receiving notification from the second terminal that data transmission is completed.

19. The method of claim 15, further comprising, after receiving the first data, creating one PDCP entity corresponding to the RLC entity.

20. A D2D (Device-to-Device) communication method which enables a first terminal of a first group to directly communicate with other terminals of the first group without relay of a base station, the method comprising:
being selected as a group owner of the first group;
receiving first data from a second terminal of the first group;
setting a destination of the first data as the first group; and
transmitting the first data.
